(19) United States
(12) Patent Application Publication
(10) Pub. No.: US 2018/0319588 A1
(43) Pub. Date: Nov. 8, 2018

(54) Decorative Trash Bags

(71) Applicant: Kerie Sturm, Paducah, KY (US)

(72) Inventor: Kerie Sturm, Paducah, KY (US)

(21) Appl. No.: 15/973,316

(22) Filed: May 7, 2018

Related U.S. Application Data
(60) Provisional application No. 62/502,101, filed on May 5, 2017.

(51) Int. Cl. B65F 1/00; A47G 19/22; A47G 19/02; A47G 21/16; B41M 1/30; B41M 1/04; B41M 1/12

(52) U.S. Cl. CPC B65F 1/0006; A47G 19/2227; A47G 19/025; A47G 21/16; B41M 1/30; B41P 2200/40; B41M 1/12; B65F 2250/114; B65F 2210/138; B41P 2200/12; B41M 1/04

(57) ABSTRACT

A waste-receptacle liner; the waste-receptacle liner includes a bag-body having an inner-volume and an outer-shell. The outer-shell includes at least one functional decorative indicium thereon. Further, the waste-receptacle liner may be provided in a supply-kit for an event such as a birthday party, anniversary, etc. The waste-receptacle liner is useful for providing a decorative trash bag for matching a theme of a party and such that a party can be readily recognizable to attendees and maintenance personnel.

### CROSS REFERENCE TO RELATED APPLICATION

The present application is related to and claims priority to U.S. Provisional Patent Application No. 62/502,101 filed May 5, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of trash bags and more specifically relates to functional decorative trash bags.

### 2. Description of Related Art

It is common to provide a liner, such as a disposable bag in a receptacle, such as a trash basket. Typically, such a liner is a plastic bag which is placed inside of the receptacle to protect it against soiling of its interior and to facilitate disposal of trash. The disposable bags are typically only available in two colors: black and white. Boring black and white trash bags can take away from the look and ambience of a party theme and it may be difficult to identify as to which party the trash belongs to. Birthday parties, baby showers, and other events outfitted with plain black and white trash bags may be undesirable and look out of place. People may feel disappointed with how their party decor looks with plain trash bags. A suitable solution is desired.

U.S. Pub. No. 2001/0041024 to Jean Tobin Zawlocki relates to a decorative waste receptacle liner. The described decorative waste receptacle liner includes a waste receptacle liner having a decorative pattern 30 printed on both the inside surface and outside surface 16 of the liner and the method and process for making same.

### BRIEF SUMMARY OF THE INVENTION

In view of the foregoing disadvantages inherent in the known trash bags art, the present disclosure provides a novel functional decorative trash bag. The general purpose of the present disclosure, which will be described subsequently in greater detail, is to provide a decorative trash bag for matching a theme of a party to help in organization.

A waste-receptacle liner is disclosed herein. The waste-receptacle liner includes a bag-body which may include an inner-volume defined by an outer-shell. Further, the bag-body may include a bottom-edge and an open-top opposite the bottom-edge and relative to the waste-receptacle when installed. The inner-volume may include a bag-capacity greater than the receptacle-capacity. In addition, the outer-shell of the bag-body may include at least one functional decorative-indicium thereon.

A method of using waste-receptacle liner is also disclosed herein. The method of using waste-receptacle liner may comprise the steps of: providing the waste receptacle liner as above; choosing a desired at least one functional decorative-indicium; selecting an ink-type; positioning the outer-shell of the bag-body for printing; and printing the desired at least one decorative-indicium onto the outer-shell of the bag-body via a printing-means.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, functional decorative trash bags, constructed and operative according to the teachings of the present disclosure.

FIG. 1 is a front perspective view of the waste-receptacle liner during an ‘in-use’ condition, according to an embodiment of the disclosure.

FIG. 2 is a front perspective view of the waste-receptacle liner of FIG. 1, according to an embodiment of the present disclosure.

FIG. 3A is a front-side perspective view of the waste-receptacle liner of FIG. 1, according to an embodiment of the present disclosure.

FIG. 3B is a front-side perspective view of the waste-receptacle liner of FIG. 1, according to an embodiment of the present disclosure.

FIG. 4 is a front perspective view of the waste-receptacle liner of FIG. 1, according to an embodiment of the present disclosure.

FIG. 5 is a flow diagram illustrating a method of use for the waste-receptacle liner, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a trash bags and more particularly to functional decorative trash bags as used to improve the function and use of trash bags.

Generally, disclosed are themed trash bags designed to match party décor. Further, the disclosure may include a party theme kit fitted with the garbage bags, cups, plates, utensils, balloons, tablecloths, and other desired party items. This may ensure all decorations at a party are coordinated and maintain a desired, stylish look. The trash bags may conveniently fit into 13-gallon and 30-gallon trash receptacles, allowing users to simply remove the bag and tie it off for disposal. The party can be organized and maintained by ready identification of all of the garbage bags, cups, plates, utensils, balloons, tablecloths and the like for attendees and maintenance personnel alike.

The trash bags may be decorative (functionally) and capable of being included in a themed party kit for birthdays, anniversaries, and more. The trash bags may be intended to match other party décor such as cups, plates, tablecloths, and the like, each outfitted with a specific logo, design, and/or color to aid in ready identification. The trash bags may be designed to replace plain black and white trash bags in order to maintain the desired look of a party or event as serve to differentiate from other parties that may be occurring. The bags may be available in the kit or in packages of two.

The trash bags may be constructed using durable, flexible plastic. Each bag can be customized and designed with virtually any type of indicia or color. The bags may be available in 13-gallon and 30-gallon sizes for additional convenience. Exact size, measurement, construction, and design specifications may vary upon manufacturing.

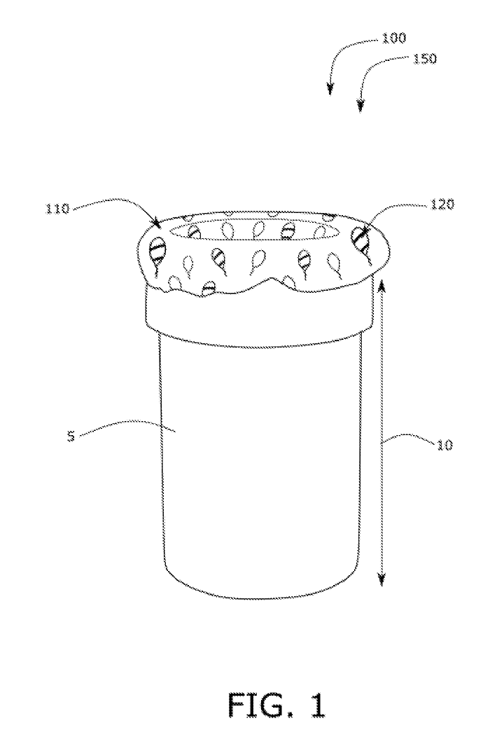

Referring now more specifically to the drawings by numerals of reference, there is shown in FIGS. 1-4, various views of a waste-receptacle liner 100.

FIG. 1 shows a waste-receptacle liner 100 during an ‘in-use’ condition 150, according to an embodiment of the present disclosure. As illustrated, the waste-receptacle liner 100 may include a bag-body 110. As shown, the bag-body 110 may include at least one functional decorative-indicium 120 thereon. Further, the waste-receptacle liner 100 may be configured for removable installation into a waste-receptacle 5 including a receptacle-capacity 10.

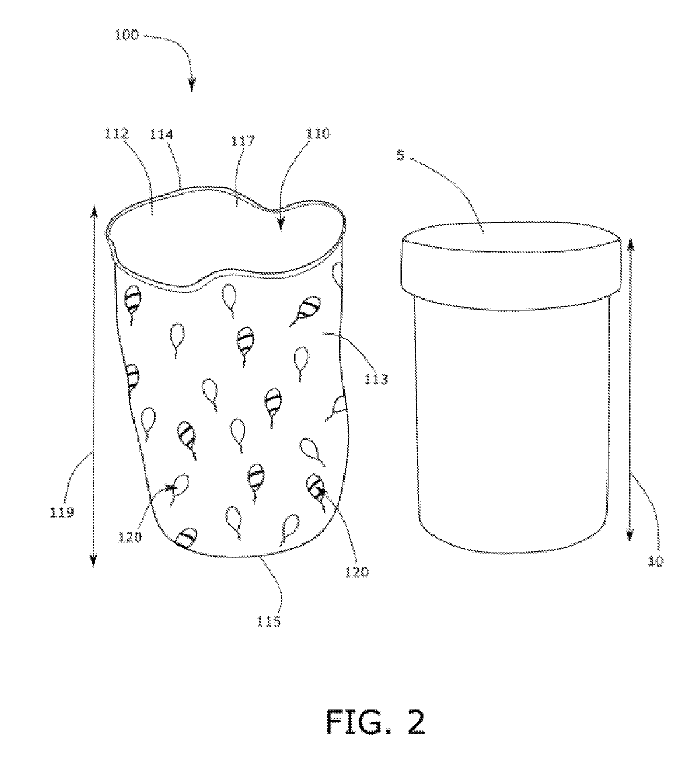

Referring now to FIG. 2 showing a front perspective view of the waste-receptacle liner 100 of FIG. 1, according to an embodiment of the present disclosure. The bag-body 110 may include an inner-volume 112 defined by an outer-shell 113. Further, the bag-body 110 may include a bottom-edge 115 and an open-top 117 opposite the bottom-edge 115 and relative to the waste-receptacle when installed. The inner-volume 112 may include a bag-capacity 119 greater than the receptacle-capacity 10. For example, the receptacle-capacity 10 may be at least 13 gallons. In another example, the receptacle-capacity 10 may be at least 30 gallons. Further, the outer-shell 113 of the bag-body 110 may include a thickness 114 of at least 0.66 mil. In a preferred embodiment, the outer-shell 113 of the bag-body 110 may include a thickness 114 of between 0.66 mil and 0.95 mil. Other capacities may be contemplated.

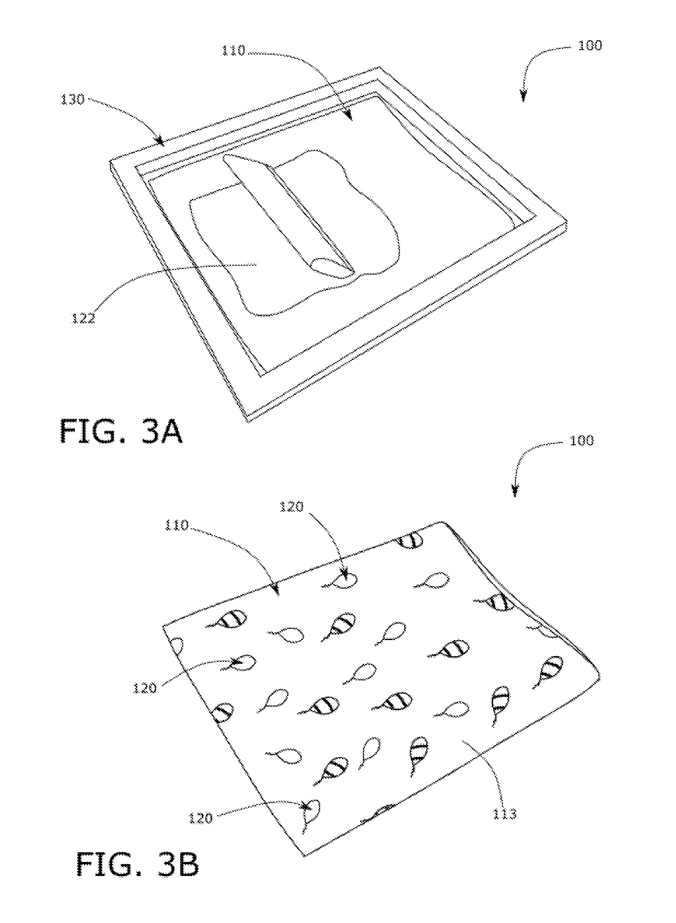

FIG. 3A-3B show front-side perspective views of the waste-receptacle liner 100 of FIG. 1, according to an embodiment of the present disclosure. As shown, the outer-shell 113 of the bag-body 110 may include at least one functional decorative-indicium 120 thereon. In the preferred embodiment, the at least one functional decorative-indicium 120 may comprise a plurality of functional decorative-indicia. The at least one functional decorative-indicium 120 may provide functional utility to the waste-receptacle liner 100. For example, the at least one functional decorative-indicium 120 may provide identifiability to the waste-receptacle liner 100. In another example, the at least one functional decorative-indicium 120 may provide an aesthetic appearance for events. For example, the at least one decorative-indicium 120 may include carious colors, logos, designs, etc. In one embodiment, the at least one functional decorative-indicium 120 may be customizable to a users' preference. As such the party may be readily identified as “Suzy's 4^{th} Birthday”. Those attending Susy's 4^{th} birthday can readily see which event it is amidst other parties. Also, those removing the filled bags can count them as needed. Unused waste-receptacle liners 100 can be returned to Susy's parents as well as other items from Susy's party.

In the preferred embodiment, the at least one functional decorative-indicium 120 may be ink 122. In this embodiment, the ink 122 may be powdered-ink, liquid-ink, etc. The ink 122 may be chosen and formulated to reduce a risk of potential static or ink pick-off. Further, the ink 122 may include an ink film-thickness of 0.3 mil. Other thicknesses are contemplated, however, it should be appreciated that the ink-film may consist of a thickness 114 that minimizes a tendency for the bag-body 110 to curl or pucker. In an embodiment with liquid-ink 122, the ink 122 may be water-based and may minimize distortion. A further example may include ultraviolet-cured screen ink.

The at least one functional decorative-indicium 120 may be applied to the outer-shell 113 of the bag-body 110 via a printing-means 130. Examples of printing-means 130 may be silk-screen printing, screen-process printing, flexographic printing, etc. A wide variety of printing-means 130 are contemplated. Corona treatment may be used on the bag-body 110 prior to application of the ink 122. This may be particularly useful when using silk-screen printing as the printing-means 130 as the corona treatment may increase bonding characteristics of the bag-body 110, thus helping the at least one functional decorative-indicia 120 adhere to the bag-body 110.

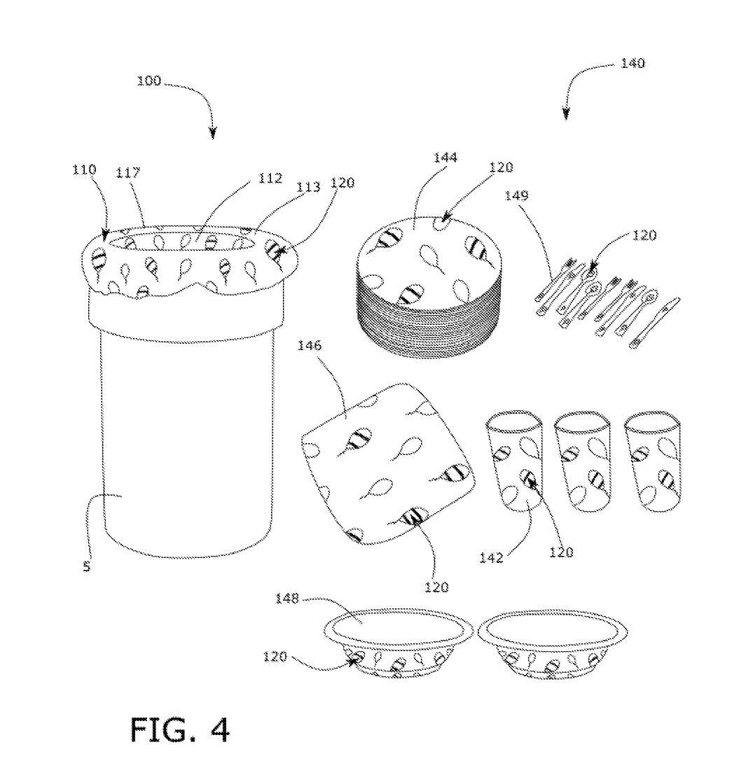

FIG. 4 shows a front perspective view of the waste-receptacle liner 100 of FIG. 1, according to an embodiment of the present disclosure. As shown, the waste-receptacle liner 100 may be sold as part of a supply-kit 140 for an event. The supply-kit 140 may include the waste-receptacle liner 100 as above. The waste-receptacle liner 100 may include the inner-volume 112 defined by the outer-shell 113. Further, the bag-body may include the bottom-edge 115 and the open-top 117 opposite the bottom-edge 115 (FIG. 2) and relative to the waste-receptacle when installed. In addition, the inner-volume 112 may include the bag-capacity 119 (FIG. 2) greater than the receptacle-capacity 10 (FIG. 2). The supply-kit 140 may further include at least one cup 142 configured to hold a liquid and at least one plate 144 configured to hold a food-item. In the preferred embodiment, the waste-receptacle liner 100, the at least one cup 142 and the at least one plate 144 may each include the at least one functional decorative-indicium 120 thereon. Each of the parts of the supply-kit 140 may be part of a theme such that each of the at least one functional decorative-indicium 120 are the same. In the preferred embodiment, the at least one functional decorative-indicium 120 may comprise a plurality of functional decorative-indicia. The various items may also be printed with naming thereon, for example: “Susy's 4^{th} Birthday”, and “Susy's cup”, “Angela's cup”, “Jeremy's cup”, to prevent wastage and also to help prevent the spread of germs between the guests/attendees.

Further, the supply-kit 140 may include at least one tablecloth 146 configured for removable installation over a table and including the at least one functional decorative-indicium 120 thereon; at least one bowl 148 configured to hold the food-item and including the at least one functional decorative-indicium 120 thereon; and at least one cutlery-item 149 configured for picking up the food-item and including the at least one functional decorative-indicium 120 thereon. The at least one cutlery-item 149 may be a knife, fork, spoon, etc.

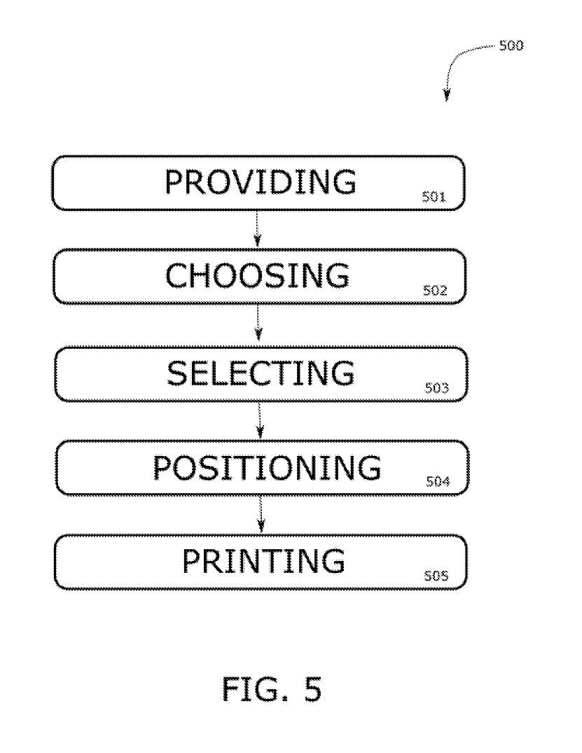

Referring now to FIG. 5, a flow diagram illustrating a method of applying at least one functional decorative-indicium to a waste receptacle liner 500, according to an embodiment of the present disclosure. As illustrated, the method of applying at least one functional decorative-indicium to a waste receptacle liner 500 may include the steps of: step 501, providing the waste-receptacle liner 100 as above; step two 502, choosing a desired at least one functional decorative-indicium 120; step three 503, selecting an ink-type; step four 504, positioning the outer-shell 113 of the bag-body 110 for printing; and step five 505, printing the desired at least one functional decorative-indicium 120 onto the outer-shell 113 of the bag-body 110 via a printing-means 130. Examples of the printing-means 130 may include silk-screen printing, screen-process printing, and flexographic printing. Further, the ink-type may be the ink including a film thickness of 0.3 mil.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for waste-receptacle liner 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A waste-receptacle liner for removable installation into a waste-receptacle, the waste-receptacle including a receptacle-capacity, the waste-receptacle liner comprising:
a bag-body including an inner-volume defined by an outer-shell, the bag-body further including a bottom-edge and an open-top opposite the bottom-edge and relative to the waste-receptacle when installed, and wherein the inner-volume includes a bag-capacity greater than the receptacle-capacity; and
wherein the outer-shell of the bag-body includes at least one functional decorative-indicium thereon.

2. The waste-receptacle liner of claim 1, wherein the at least one functional decorative-indicium comprises a plurality of functional decorative-indicia.

3. The waste-receptacle liner of claim 2, wherein the at least one functional decorative-indicium is ink.

4. The waste-receptacle liner of claim 3, wherein the at least one functional decorative-indicium is applied to the outer-shell of the bag-body via a printing-means.

5. The waste-receptacle liner of claim 4, wherein the printing-means is silk-screen printing.

6. The waste-receptacle liner of claim 4, wherein the printing-means is screen-process printing.

7. The waste-receptacle liner of claim 4, wherein the printing-means is flexographic printing.

8. The waste-receptacle liner of claim 1, wherein the outer-shell of the bag-body includes a thickness of at least 0.66 mil.

9. The waste-receptacle liner of claim 8, wherein the outer-shell of the bag-body includes a thickness of between 0.66 mil and 0.95 mil.

10. The waste-receptacle liner of claim 1, wherein the receptacle-capacity is at least 13 gallons.

11. A supply-kit for an event comprising:
a waste-receptacle liner for removable installation into a waste-receptacle, the waste-receptacle including a receptacle-capacity, the waste-receptacle liner comprising a bag-body including an inner-volume defined by a outer-shell, the bag-body further including a bottom-edge and an open-top opposite the bottom-edge and relative to the waste-receptacle when installed, and wherein the inner-volume includes a bag-capacity greater than the receptacle-capacity;
at least one cup configured to hold a liquid;
at least one plate configured to hold a food-item; and
wherein the waste-receptacle liner, the at least one cup and the at least one plate each include at least one matching functional decorative-indicium thereon such that a party can be readily recognizable to attendees and maintenance personnel.

12. The supply-kit of claim 11, wherein the at least one functional decorative-indicium is a plurality of functional decorative-indicia.

13. The supply-kit of claim 1, further comprising at least one tablecloth configured for removable installation over a table, and wherein the tablecloth includes the at least one functional decorative-indicium thereon.

14. The supply-kit of claim 1, further comprising at least one bowl configured to hold the food-item, and wherein the bowl includes the at least one functional decorative-indicium thereon.

15. The supply-kit of claim 1, further comprising at least one cutlery-item configured for picking up the food-item, and wherein the cutlery-item includes the at least one functional decorative-indicium thereon.

16. A method of applying at least one functional decorative-indicium to a waste receptacle liner, the method comprising the steps of:
providing the waste receptacle liner, the waste-receptacle liner for removable installation into a waste-receptacle, the waste-receptacle including a receptacle-capacity, the waste-receptacle liner comprising:
a bag-body including an inner-volume defined by an outer-shell, the bag-body further including a bottom-edge and an open-top opposite the bottom-edge and relative to the waste-receptacle when installed, and wherein the inner-volume includes a bag-capacity greater than the receptacle-capacity;
choosing a desired at least one functional decorative-indicium;
selecting an ink-type;
positioning the outer-shell of the bag-body for printing; and
printing the desired at least one functional decorative-indicium onto the outer-shell of the bag-body via a printing-means such that a party can be readily recognizable to attendees and maintenance personnel when used.

17. The method of claim 16, wherein the printing-means is silk-screen printing.

18. The method of claim 16, wherein the printing-means is screen-process printing.

19. The method of claim 16, wherein the printing-means is flexographic printing.

20. The method of claim 16, wherein the ink-type is an ink including a film thickness of 0.3 mil.
